(19) United States
(12) Patent Application Publication
(10) Pub. No.: US 2026/0330264 A1
(43) Pub. Date: Oct. 22, 2026

(54) Hardware Processor for Deterministic Contractive State Evolution Using a Fixed Point Update Operator

(71) Applicant: Matt Thornton, Houston, TX (US)

(72) Inventor: Matt Thornton, Houston, TX (US)

(21) Appl. No.: 19/707,753

(22) Filed: Jun. 15, 2026

Related U.S. Application Data
(63) Continuation of application No. 19/543,866, filed on Feb. 19, 2026.

(51) Int. Cl. G06N 5/04

(52) U.S. Cl. CPC G06N 5/04

(57) ABSTRACT

A hardware processor is disclosed for deterministic, contractive state-evolution using an iteratively applied fixed-point update operator. The processor implements Θ(sₜ)=f(Asₜ+b) in silicon using fixed-point state registers, a linear transformation unit, a bias unit, a bounded nonlinearity, and a convergence unit configured to halt when ∥sₜ₊₁−sₜ∥ falls below a threshold. In some embodiments, an energy-guided correction term −η∇E(sₜ) is incorporated to form a dissipative dynamical system. The architecture provides deterministic, bounded, and convergent state evolution suitable for reasoning substrates and other systems requiring stable fixed-point computation. The processor may be realized in digital, analog, optical, photonic, magnetic, atomic, or other classical substrates capable of executing contractive operators. Mesh-based embodiments allow multiple processors to operate as convergent dynamical nodes exchanging state information across a distributed array. The disclosed hardware enables native execution of contractive update operators with deterministic convergence guarantees, addressing limitations of stochastic or nondeterministic AI computation models.

### CROSS-REFERENCE TO RELATED APPLICATIONS

This application is a continuation of U.S. application Ser. No. 19/543,866, filed Feb. 19, 2026, titled “Systems and Methods for an Operator Separated Cognitive Architecture for AI Reasoning”, the entirety of which is incorporated herein by reference.

### FIELD OF THE INVENTION

The invention relates to hardware processors that implement deterministic operator-based state-evolution systems. More specifically, it concerns fixed-point hardware embodiments of a contractive update operator used in reasoning substrates.

### BACKGROUND OF THE INVENTION

Existing AI and cognitive systems rely on stochastic or non-deterministic computation models that lack convergence guarantees and do not provide substrate-level control. Prior architectures do not implement a deterministic contractive operator loop in hardware, nor do they provide fixed-point evaluation as a native hardware primitive. There is a need for processors that execute a bounded, convergent update operator directly in silicon to support deterministic reasoning substrates.

### SUMMARY OF THE INVENTION

The disclosed processor implements a deterministic contractive update operator Θ(s) in hardware, enabling fixed-point convergence of a state vector through iterative application of Θ. In one embodiment, Θ(s)=W·s+b is executed using fixed-point multiply-accumulate units with a convergence check. In another embodiment, an energy-guided correction term is applied to form a dissipative dynamical system. The processor includes state registers, weight memory, bias memory, a MAC array, a delta unit, a norm unit, and a control FSM. The system may operate as a standalone reasoning processor or as part of a multicore substrate mesh.

### BRIEF DESCRIPTION OF THE DRAWINGS

FIG. 1 illustrates an example processor architecture implementing a contractive update operator Θ, including state registers, a matrix-multiply unit, a bias unit, and a convergence unit.

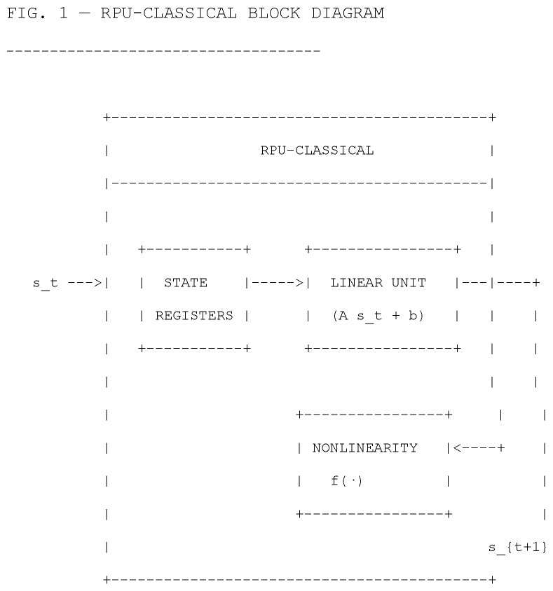

FIG. 2 illustrates an example update cycle showing iterative application of Θ(s) to produce successive state vectors until a convergence threshold is met.

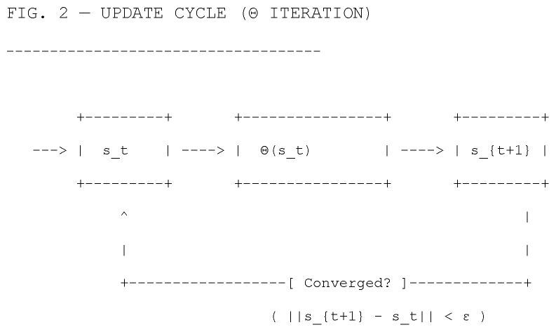

FIG. 3 illustrates an embodiment of a fixed-point hardware loop configured to compute sₜ₊₁=f(Asₜ+b).

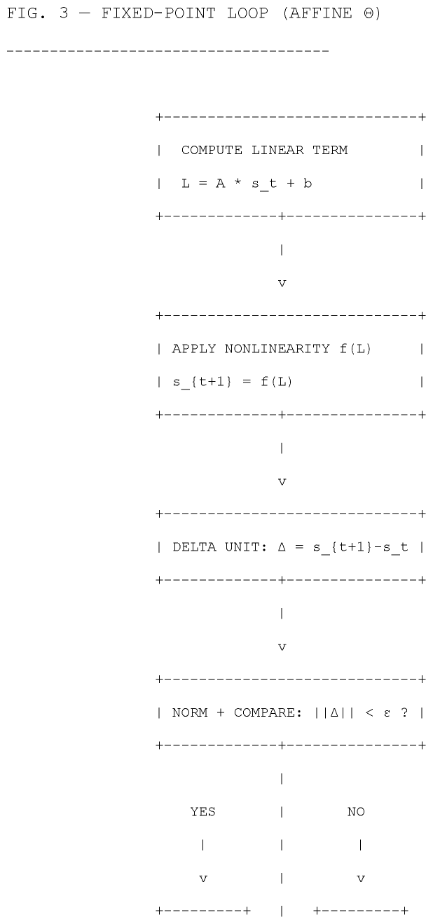

FIG. 4 illustrates an embodiment including an optional energy-guided correction unit for dissipative updates.

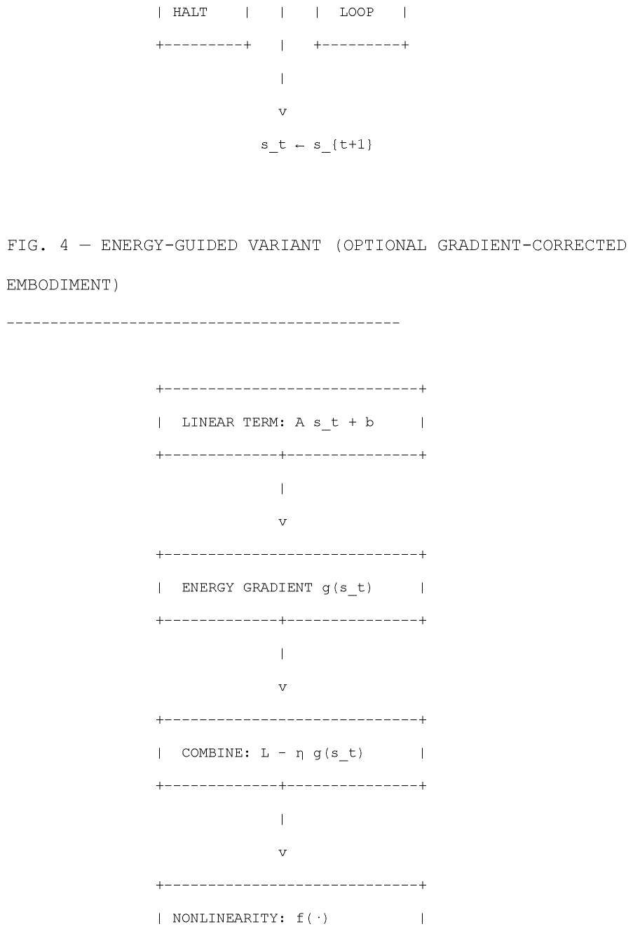

FIG. 5 illustrates a multicore arrangement of processors operating as a mesh of convergent dynamical nodes.

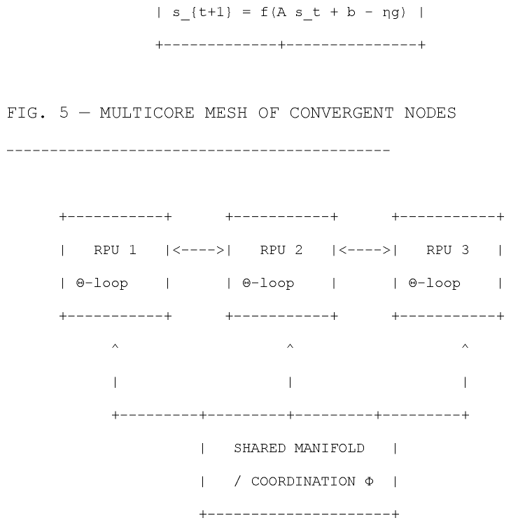

### DETAILED DESCRIPTION OF THE INVENTION

The embodiments described herein relate to hardware processors configured to implement a deterministic contractive update operator Θ(s) applied iteratively to a state vector sₜ. In one embodiment, the processor includes a plurality of fixed-point state registers storing the current state sₜ, a matrix-multiply unit configured to compute Asₜ, a bias unit configured to add a fixed-point vector b, and update logic configured to compute sₜ₊₁=f(Asₜ+b), where A is a contractive matrix and f is a bounded nonlinearity or projection function.

The processor further includes a convergence unit configured to compute a difference measure between sₜ and sₜ₊₁ and to determine whether a convergence threshold has been met. A control unit orchestrates iterative application of Θ until convergence or until a maximum iteration count is reached. In some embodiments, an energy-guided correction unit computes a gradient or strain term VE(S) and applies a dissipative update of the form sₜ₊₁=f(Asₜ+b−η∇E(sₜ)). The processor may be implemented in any physical medium capable of realizing the contractive update operator, including but not limited to silicon, magnetic, optical, photonic, polymer, printed, or photo-embossed substrates.

In one embodiment, the processor is implemented as a fixed-point digital circuit including a multiply-accumulate array, bias registers, a delta computation unit, a norm unit, and a comparator. In another embodiment, the processor is implemented using analog, mixed-signal, or non-Von-Neumann substrates capable of performing the required linear and nonlinear transformations. In yet another embodiment, multiple processors are arranged in a mesh or network topology, each operating as a convergent dynamical node.

The processor may be implemented in any physical medium capable of realizing the contractive update operator, including but not limited to silicon, magnetic, optical, photonic, polymer, printed, atomic, nuclear, or quantum, or other energy guided inspired substrates.

The embodiments described herein provide deterministic, bounded, and convergent state evolution suitable for reasoning substrates, control systems, optimization systems, and other applications requiring stable fixed-point computation.

References to quantum-inspired embodiments herein refer to classical implementations of energy-guided or gradient-corrected update rules and do not require quantum computing hardware.

Implementation Example (Pseudocode) The following pseudocode provides one non-limiting example of an implementation of the iterative update process described herein. This example illustrates how a processor may apply the operator Θ to a state vector, evaluate convergence, and update the state across successive iterations. The pseudocode is provided solely to demonstrate one possible realization of the described architecture and does not limit the scope of the claims, which encompass all hardware, software, and hybrid embodiments capable of performing the described operations.

| ### Implementation Example (Pseudocode) | |
|---|---|
| # One non-limiting example of an iterative state-update | |
| engine. | |
| # Θ is any contractive operator implemented by the | |
| processor. | |
| function RPU_Iterate(state): | |
| repeat: | |
| next_state = Theta(state) | # apply hardware |
| operator | |
| delta = Norm(next_state − state) | # compute change |
| magnitude | |
| state = next_state | # advance state |
| until delta < epsilon | # convergence |

threshold
return state

1. A system comprising a processor configured to iteratively apply a contractive update operator Θ to a state vector sₜ to produce a sequence of states converging to a fixed point.

2. The system of claim 1, wherein the processor comprises state registers, an operator unit configured to compute Θ(sₜ), a convergence unit, and a control unit configured to repeat updates until a convergence threshold is met.

3. The system of claim 1, wherein Θ(sₜ)=f(Asₜ+b), with A contractive and f a bounded nonlinearity.

4. The system of claim 1, wherein Θ(sₜ) includes an energy-guided correction term of the form f(Asₜ+b−η∇E(sₜ)).

5. The system of claim 1, wherein the processor is implemented in a physical medium selected from silicon, magnetic, optical, photonic, polymer, printed, atomic, nuclear, or quantum-inspired substrates.

6. The system of claim 1, comprising a plurality of processors arranged in a mesh or distributed array, each configured to apply a contractive update operator and exchange state information with neighboring processors.

7. The system of claim 6, wherein the plurality of processors form a convergent dynamical network.

8. A method comprising iteratively applying a contractive update operator Θ to a state vector until a convergence threshold is satisfied.

9. The method of claim 8, wherein Θ(sₜ)=f(Asₜ+b).

10. The method of claim 8, wherein Θ(sₜ) includes a gradient-corrected term of the form f(Asₜ+b−η∇E(sₜ)).

11. The method of claim 8, further comprising applying Θ across a distributed array of processors that exchange state information.

12. A non-transitory computer-readable medium storing instructions that, when executed by one or more processors, cause the processors to iteratively apply a contractive update operator Θ to a state vector until convergence.

13. The medium of claim 12, wherein the instructions implement Θ(sₜ)=f(Asₜ+b).

14. The medium of claim 12, wherein the instructions implement Θ(sₜ)=f(Asₜ+b−η∇E(sₜ)).

15. The medium of claim 12, wherein the instructions cause distributed processors to exchange state information during convergence.

16. The system of claim 1, wherein the operator unit comprises a fixed-point multiply-accumulate array.

17. The system of claim 1, wherein the operator unit comprises an analog, optical, or photonic linear transformation element.

18. The system of claim 1, wherein the operator unit comprises a magnetic, atomic, or nuclear-inspired transformation element.

19. The system of claim 1, wherein the convergence unit computes a norm of a difference vector Δ=sₜ₊₁−sₜ.

20. The system of claim 1, wherein Θ comprises any deterministic, bounded, contractive operator mapping a state vector to a subsequent state.

21. A system comprising a processor configured to apply an operator Θ to a state vector, wherein Θ comprises any deterministic, bounded operator that maps a state vector to a subsequent state vector and is iteratively applied until a convergence criterion is satisfied.

22. The system of claim 21, wherein the processor is implemented in an optical or photonic substrate configured to perform linear or nonlinear transformations.

23. The system of claim 21, wherein the processor is implemented in a magnetic or spintronic substrate configured to realize the operator Θ.

24. The system of claim 21, wherein the processor is implemented in an atomic or nuclear-inspired substrate configured to realize dissipative or gradient-corrected transformations.
